(19) United States
(12) Patent Application Publication
(10) Pub. No.: US 2026/0082162 A1
(43) Pub. Date: Mar. 19, 2026

(54) METHOD OF OPERATING A HEARING DEVICE AND HEARING DEVICE

(71) Applicant: Sivantos Pte. Ltd., Singapore (SG)

(72) Inventors: Thomas KÜBERT, Erlangen (DE); Cecil WILSON, Erlangen (DE)

(21) Appl. No.: 19/271,914

(22) Filed: Jul. 17, 2025

(30) Foreign Application Priority Data
Jul. 25, 2024 (DE) 10 2024 206 995.7

(51) Int. Cl. H04R 25/00

(52) U.S. Cl. CPC H04R 25/505; H04R 2225/41; H04R 2430/01

(57) ABSTRACT

A method operates a hearing device in which an input signal is created based on an ambient sound by a microphone. An output signal is provided based on the input signal, and an output sound is emitted based on the output signal by a receiver. The non-processed ambient sound present in the area of the receiver is identified, and the ratio between the non-processed ambient sound and the output sound is identified for different frequency bands. An amplitude of the output signal is changed for the frequency band in which the ratio is between an upper limit value and a lower limit value.

### CROSS-REFERENCE TO RELATED APPLICATION

This application claims the priority, under 35 U.S. C. § 119, of German Patent Application DE 10 2024 206 995.7, filed Jul. 25, 2024; the prior application is herewith incorporated by reference in its entirety.

### FIELD AND BACKGROUND OF THE INVENTION

The invention relates to a method of operating a hearing device and to a hearing device. The microphone has a microphone and a receiver.

People suffering from decreased hearing usually use a hearing aid. Then, in most cases, an electromechanical sound transducer captures an ambient sound. The electrical (audio) signals created based on the ambient sound are amplified by an amplifier circuit and emitted by a further electromechanical transducer in the form of a receiver, so that an output sound is introduced into the person's ear canal. In most cases, processing of the captured audio signals is also carried out, for which a signal processor of the amplifier circuit is usually used. In this respect, the amplification is tuned to a possible hearing loss of the hearing aid wearer who will be referred to hereinafter as the user or wearer.

In this respect, it is possible for the non-processed ambient sound to enter into the person's ear canal in addition to the output sound. As such, depending on the design of the hearing device, it may enter between the hearing device and the edge of the ear canal or between the receiver inserted into the ear canal and the edge of the ear canal, so that the non-processed ambient sound may be additionally perceived by the person. Thus, the non-processed ambient sound is superimposed on the output sound. As the output sound corresponds to the processed ambient sound, with a frequency-specific amplification occurring depending on the level of hearing loss, the superimposition causes non-linear effects, i.e., artifacts, which the person may perceive as disturbing.

Such an artifact is the so-called comb filter. There, minima in the amplitude occur in the frequency spectrum of the non-processed ambient sound superimposed on the output sound in certain frequency intervals, respectively, wherein the minima go comparatively deep. Such a superimposition is perceived by the person as if being inside a tunnel. As such, the audibility of the comb filter artifact strongly depends on the type and level of the input signal.

Due to the non-linear amplification by hearing devices and user-specific adjustments, the comb filter artifact varies between different persons. Hence, it is difficult to implement solutions therefor.

One solution provides for always attenuating in the case of frequencies which are more likely to cause the comb filter artifact. Thus, these are not or only hardly perceivable by the person, even if a comb filter artifact is not to be expected based on the current situation. Moreover, this results in certain other algorithms, such as noise cancellation, not being available. Thus, the benefit of the hearing device for the person is decreased.

Another method is to only attenuate/not amplify the corresponding frequencies during operation if a high probability of the occurrence of a comb filter artifact is to be expected based on the current situation. This relies on an estimation of the superimposition which, however, is comparatively computationally intensive and prone to errors. If the respective estimation is faulty, other artifacts may occur and the perceivability for the user may also be reduced.

### SUMMARY OF THE INVENTION

An object of the invention is to present a particularly suitable method of operating a hearing device, and a particularly suitable hearing device, in particular wherein comfort for a user is increased, and wherein hardware resources are conveniently decreased.

According to the invention, this object is achieved by the features of the independent method claim regarding the method and by the features of the independent hearing device regarding the hearing device. Advantageous developments and configurations are the subject matter of the respective dependent claims.

With the foregoing and other objects in view there is provided, in accordance with the invention, a method for operating a hearing device. The method includes: generating an input signal based on an ambient sound by means of a microphone; providing an output signal based on the input signal; emitting an output sound based on the output signal by means of a receiver; and identifying non-processed ambient sound present in an area of the receiver. A ratio between the non-processed ambient sound and the output sound identified is determined for different frequency bands. An amplitude of the output signal is changed for a frequency band in which the ratio is between an upper limit value and a lower limit value.

The method serves to operate a hearing device. For example, the hearing device is an earphone or comprises an earphone and the hearing device is a headset, for example. However, particularly preferably, the hearing device is a hearing aid. The hearing aid is for assisting a person suffering from decreased hearing. In other words, the hearing aid is a medical device by means of which partial hearing loss is compensated, for example. The hearing aid is, for example, a “receiver-in-the-canal” (RIC) hearing device, a hearing aid inside the ear, such as an “in-the-ear” hearing aid, an “in-the-canal” (ITC) hearing aid or a “complete-in-canal” (CIC) hearing aid, hearing aid glasses or a pocket hearing aid. Alternatively, the hearing aid is a “behind-the-ear” hearing aid which is worn behind a pinna.

The hearing device is provided and configured to be worn on the human body. In other words, the hearing device preferably comprises a holder by means of which attachment to the human body is possible. If the hearing device is a hearing aid, the hearing device is provided and configured to be arranged behind the ear or within an ear canal, for example. In particular, the hearing device is wireless and provided and configured to be at least partially introduced into an ear canal.

The hearing device comprises a microphone which serves to capture sound. In particular, during operation, an ambient sound, i.e., sound waves, or at least a part thereof is captured by means of the microphone. Conveniently, the microphone is at least partially arranged within a housing of the hearing device and is thus at least partially protected. Suitably, the microphone is an electromechanical sound transducer. As an example, the microphone solely has a single microphone unit or multiple microphone units which may interact with each other. Conveniently, each of the microphone units has a membrane which is made to oscillate by sound waves, with the oscillations being converted into an electrical signal by means of a corresponding recording device, such as a magnet being moved in a coil. Alternatively, the microphone units are designed in a capacitive manner, and the fact is utilized that an applied electrical voltage changes when the distance of the membrane to a static surface of the microphone unit changes. As such, the electrical voltage is applied in particular between the membrane and the static surface. The microphone units are preferably designed to be omnidirectional. In this or another way, it is at least possible to produce or at least provide an electrical signal by means of the microphone which is based on the sound impinging upon the microphone, i.e., in particular the ambient sound. As such, the electrical signal constitutes an input signal.

Further, the hearing device has a receiver for emitting an output signal. Here, the output signal in particular is an electrical signal, and is designed to be digital or suitably analog, for example. Preferably, the receiver is an electromechanical sound transducer, for example a loudspeaker. Depending on the design of the hearing device, when in the intended state, the receiver is at least partially arranged within an ear canal of a user of the hearing device, i.e., a person who may also be referred to as the wearer, user or hearing aid wearer, or at least acoustically connected thereto. In particular, the hearing device mainly serves to emit the output signal by means of the receiver, with a corresponding output sound being created. In other words, the main function of the hearing device is preferably to emit the output signal so as to create the output sound.

Suitably, the hearing device comprises a signal processing unit by means of which the microphone and the receiver are signally connected. Conveniently, the hearing device has a signal processor forming the signal processing unit, for example, or at least being a component thereof. For example, the signal processor is a digital signal processor (DSP) or is implemented by means of analog components. By means of the signal processor or at least the signal processing unit, an adaptation of the input signal created by means of the microphone is achieved in particular, so that the output signal is preferably created. At least, the signal processing unit is suitable, in particular provided and configured, for this purpose. Conveniently, between the microphone and the signal processing unit, for example the signal processor, an A/D converter is arranged if the signal processor is designed as a digital signal processor. Particularly preferably, the hearing device additionally comprises an amplifier, or the amplifier is at least partially formed by means of the signal processing unit. For example, the amplifier is signally connected upstream or downstream of the signal processor.

The method provides for the input signal to be created based on the ambient sound. In other words, in particular the ambient sound is captured and the input signal is created based thereon. Suitably, the input signal is an electrical signal, and the creation is conveniently carried out by means of the microphone(s). In this case, the input signal corresponds to the non-processed ambient sound, for example, or is already processed, for example. Conveniently, the input signal has a certain directivity so that a certain part of the environment is captured predominantly, i.e., in particular sound from a certain solid angle.

Based on the input signal, an output signal is provided. For example, for this purpose, the input signal is directly mapped to the output signal. However, preferably, the input signal is at least partially processed, and the processed input signal in particular corresponds to the output signal. The processing is carried out in one operation or in multiple operations, for example. In particular, this involves frequency-specific amplification, and/or certain frequencies being mapped to other frequencies so that compression occurs. Alternatively or in combination, a time lag is at least partially extended. Preferably, for providing the output signal, preferably for the processing, the possible signal processing unit is used.

Conveniently, during processing, frequency bands are used, in particular wherein all frequencies of the respectively same frequency band are processed in the same manner. Alternatively, for example, solely a single frequency from the respective frequency band is used for this purpose, which is then added to the output signal. In contrast, the other frequencies are not processed any further. Thus, complexity is decreased. Conveniently, the frequency bands are formed such that the discretization provided in this way is not perceivable by the user.

Hereinafter, the output sound is emitted based on the output signal by means of the receiver. In particular, for this purpose, the (electrical) output signal is converted into sound waves, for which the receiver is appropriately designed. At least, the output sound is based on the output signal, and the output sound is emitted by means of the receiver when the input signal is fed thereto. Thus, the output signal is perceivably by the user, i.e., via the output sound. In particular, when using the hearing device as intended, the output sound is fed into the user's ear canal.

In the method, further, the non-processed ambient sound present in the area of the receiver is identified. When using the hearing device as intended, this area is conveniently located in the ear canal, and the area preferably comprises the eardrum. For example, the non-processed ambient sound is measured directly, for example by means of a further microphone arranged in the area of the receiver. Alternatively, the non-processed ambient sound is estimated, for which a transfer function is used in particular. As such, the transfer function is fed with the input signal in particular. For example, the transfer function is identified theoretically and/or simply results from the design of the hearing device. In this case, the transfer function is in particular the same for all users. Alternatively, for example, it is created specifically for each user, for example when adapting the hearing device to the respective user.

The ratio between the non-processed ambient sound and the output sound is identified for different frequency bands. In this case, for example, each frequency band solely has a single frequency, or preferably, each frequency band is associated with frequencies adjacent to one another. Preferably, the same frequency bands are used for this purpose, which have in particular also been used for creating the output signal.

Identifying the ratio in particular relies on the respective amplitude, and consequently, the ratio of the non-processed ambient sound entering into the ear canal past the hearing device to the possible processing by means of the signal processing unit, i.e., the output sound, is identified.

For this purpose, the output sound is measured directly, for example. However, particularly preferably, it is also identified theoretically for which purpose it is convenient to use a further transfer function. In this case, the latter deviates from the possible transfer function by means of which the non-processed ambient sound is identified. The further transfer function depends on the possible processing of the input signal. In particular, the further transfer function considers the possible frequency-selective amplification and/or a temporal offset, i.e., in particular, different time lags.

If the ratio is between an upper limit value and a lower limit value, the amplitude of the output signal is changed for this frequency band. Thus, the resulting ratio is then changed.

As a result, the amplitude is changed if the ratio is at least approximately, or even equal to, 1 and if the amplitudes of the non-processed ambient sound and the output sound are substantially the same. In this case, the possible artifacts resulting from a superimposition are comparatively pronounced, at least in comparison to a reduction at either of the two amplitudes. Thus, due to the change in the amplitude of the output sound, the strength of the possibly resulting artifact is reduced, so that the artifact, if present, is not or only slightly perceivable by a person. Thus, comfort for the user is increased.

Even in situations in which artifacts do not occur, for example, processing of the input signal always adapted to the possible hearing loss of the user is possible, which increases the comfort further. In addition, performing the method does not require comparatively complicated computations, thereby decreasing the hardware resources needed.

For example, each of the processed ambient sound and the output sound are measured to identify the ratio. However, particularly preferably, one of them, or conveniently both, i.e., the non-processed ambient sound and the output sound, are identified based on the possible respective transfer function. Thus, in particular, the ratio is already created before the output sound is actually emitted. Thus, it is possible to identify the ratio already before emitting the output sound, which is what is conveniently done. Conveniently, if the ratio is then between the upper limit value and the lower limit value, the amplitudes in the output signal are changed in a suitable manner, and only then the output sound is emitted based on the changed output signal. Thus, formation of artefacts is completely avoided, further increasing the comfort.

For example, this is performed solely for a single frequency band. Alternatively, this is performed for multiple frequency bands. Conveniently, this adaptation of the amplitude is changed for all or at least many frequency bands for which the respective ratio is between the upper limit value and the lower limit value. Thus, such possibilities of interference are decreased for all or many frequency bands, thereby further improving perceivability. As such, different frequency bands are associated with different upper/lower limit values, for example. However, preferably, they are the same for all of the frequency bands, thereby decreasing complexity.

For example, the change in amplitude is always the same or preferably depends on the ratio, i.e., the value of the ratio. Alternatively or in combination, the change in amplitude depends on further conditions, so that a current situation and/or different artifacts are taken into account in particular. Thus, comfort is further increased.

For example, for changing the amplitude, it is set to a specified value. As an example, the amplitude is increased. However, particularly preferably, it is decreased. Thus, this frequency range of the output signal is only perceivable by the user to a lower extent via the associated output sound. However, as the non-processed ambient sound for this frequency band has an amplitude of the same magnitude, the corresponding frequency band will still be perceivable. Thus, it is substantially not perceivable by the user that the amplitude of the output signal has been reduced, and perceivability also continues to be high. Thus, comfort is increased.

For example, 20 dB or 10 dB are used as the upper limit value. Particularly preferably, 6 dB is adopted as the upper limit value. Alternatively or in combination, −20 dB or −10 dB is used as the lower limit value, for example. Conveniently, −6 dB is used as the lower limit value. In particular, 6 dB is adopted as the upper limit value and −6 dB is adopted as the lower limit value. Thus, the amplitude is adapted in particular solely if the amplitude of the non-processed ambient sound and the output sound are substantially at the same level, i.e., if the probability for artifacts to occur is high.

Conveniently, in the method, solely the amplitude for frequency bands with frequencies of between 50 Hz and 5 kHz, between 100 Hz and 3 kHz or between 200 Hz and 2.5 kHz is identified and the amplitude is optionally changed. Conveniently, solely the amplitude for frequency bands with frequencies of between 250 Hz and 2 kHz is changed. In particular, the ratio is respectively solely identified for such frequency bands and thus also in particular solely uses the possible respective transfer function for the non-processed ambient sound and/or the output sound. Thus, complexity is reduced. In addition, a comb filter artifact predominantly occurs at frequencies of between 250 Hz and 2 kHz or is at least disturbing to the user in this range. Thus, the adaptation is solely performed in the frequency range relevant to the user, whereas the unchanged output signal is used otherwise. Thus, complexity is reduced, nevertheless not diminishing comfort. Moreover, in this manner, desired effects included by creating the output signal correspondingly are not unintentionally undone, for example.

Preferably, for changing the amplitude of the output signal in the frequency band, the associated amplification factor is changed by means of which the output signal is created. In particular, for creating the output signal, the input signal is split into different frequency bands, wherein the individual frequency bands are amplified by a respective associated amplification factor. Thus, based on the change in the associated amplification factor, the resulting ratio is already changed during the operation in which the output signal is created, so that the number of operations needed is decreased. Thus, complexity is reduced.

For example, the amplification factor is increased. However, conveniently, it is lessened, so that this portion of the output signal is substantially not perceivable. Thus, an overly high volume of the output sound is avoided which would otherwise lead to diminished comfort.

For example, the amplification factor is solely changed for the frequency band for which the ratio is between the upper and lower limit values. However, particularly preferably, an adaptation of the adjacent frequencies is also carried out, preferably wherein a corresponding target function is specified for the adaptation. This target function is in particular designed to be notch-like. Thus, a smooth transition is provided for the change, thus increasing comfort. For example, for changing the amplification factor, it is multiplied with a specified number. However, particularly preferably, a certain constant is added/subtracted. Preferably, the latter is between 1 dB and 18 dB, suitably between 5 dB and 15 dB, and substantially equal to 10 dB, for example. Thus, due to the change in amplitude, the ratio is in particular also adapted such that further adaptation is not required afterwards as the ratio is outside of the upper and lower limit values.

For example, the amplification factor is comparatively abruptly altered if the ratio is between the upper and lower limit values. However, particularly preferably, the amplification factor is gradually adapted up to the target value. In particular, the latter is specified by means of a look-up table or a function. When the target value is reached, further adaptation is conveniently not carried out. In particular, the target value is between 5 dB and 15 dB, and suitably equal to 10 dB. Due to a gradual adaptation, an abrupt change perceivable by the user as unpleasant is avoided. Consequently, comfort is increased.

For example, the amplitude is always changed if the ratio is between the upper limit value and the lower limit value. However, preferably, this is solely carried out if a criterion, i.e., an additional condition, is met. This ensures that, for example in situations where the ratio is desired to be between the upper and lower limit values, the amplitude is not changed which would otherwise cancel a desired effect, for example. Thus, it is possible to ensure that the adaptation is solely done if undesired artifacts are present or at least possible, thereby increasing comfort.

As such, the criterion comprises one or more conditions, for example, and if at least one is met, the criterion is met. Alternatively, it is required for this purpose, for example, that certain conditions or a certain number of conditions is met for the criterion to be met. Alternatively, it is required for this purpose, that all conditions are met.

For example, the change in amplitude solely occurs as a function of the criterion being met. However, particularly preferably, the criterion is also applied to determine the amount of the change in amplitude. Thus, removing undesired artifacts in a targeted manner is made possible.

Conveniently, the criterion is solely met if the amplitude is less than a reference amplitude by more than a third limit value, i.e., a notch is present in the frequency spectrum. As such, the reference amplitude is in particular the average of all amplitudes of the frequency range or at least the adjacent frequency bands. Alternatively, the criterion is solely met if the amplitude is greater than the respective reference amplitude by more than a fourth limit value, i.e., a peak is not present. Preferably, the third and fourth limit values are equally large and in particular greater than 10 dB or at least greater than 5 dB. In this case, a change in amplitude thus substantially solely occurs if a type of comb structure, i.e., in particular a comparatively sharp minimum or maximum, is present. In this respect, for example, it is sufficient for the amplitude to only once be less/greater than the reference amplitude by the respective limit value.

For example, the criterion is solely met if, for a first number of frequency bands, the respective amplitude is less than the reference amplitude by more than the third limit value. Alternatively or particularly preferably in combination, the criterion is solely met if, for a second number of frequency bands, the respective amplitude is greater than the respective reference amplitude by more than the fourth limit value. As such, the reference amplitude is in particular associated with the respective frequency band and in particular differs between the individual frequency bands. Consequently, each individual frequency band is not only considered separately but as a group. In this respect, the first number is preferably greater than 1 and the second number is conveniently greater than 2. Consequently, the adaptation is solely made if a comb structure is at least slightly present in the frequency spectrum, which, as a result, comprises at least 3 peaks and 2 notches. In particular, this avoids that a desired effect or the like is prevented due to the adaptation, thereby improving comfort.

Alternatively or particularly preferably in combination, the criterion is solely met if the ambient sound is associated with a certain class. In other words, the ambient sound is first checked and classified. As such, in particular, a certain class used consists in a comparatively large amount of stationary noise being present. This is in particular the case if comparatively many speakers are present or engine noises are dominant, i.e., in particular traffic noise is present or machines are being moved.

Alternative or particularly preferably in combination, the criterion is solely met then and only then if the strength of the possible comb filter artifact exceeds a certain threshold value, such as 0.5, or if the comb filter artifact occurs due to the corresponding processing.

Preferably, the criterion is not met, in particular independent of whether further possible conditions are met, if the frequency band for which the ratio is between the upper and lower limit values solely corresponds to speech, i.e., in particular speech of the user or speech of other people. In other words, the amplitude in this frequency band is solely caused by the speech and there are no further sources of sound for these frequencies. Alternatively or in combination, the criterion is not met if the frequency band solely corresponds to tonal music. In this case, in particular the corresponding amplitude is present due to music which the user wants to perceive, so that in particular a change in the amplitude would result in distorted enjoyment of the music. Moreover in this case, the presence of a comb filter artifact is rather improbable or is at least not perceived as disturbing.

For example, the hearing device is a headset or, particularly preferably, a hearing aid. As an example, the hearing aid is a “receiver-in-the-canal” (RIC) hearing device, a hearing aid inside the ear, such as an “in-the-ear” hearing aid, an “in-the-canal” (ITC) hearing aid or a “complete-in-canal” (CIC) hearing aid, hearing aid glasses or a pocket hearing aid. Alternatively, the hearing aid is a “behind-the-ear”hearing aid which is worn behind a pinna.

The hearing device has a microphone. The latter is designed to be omnidirectional, for example, or it is suitably possible to change a directionality of the microphone. For this purpose, the microphone preferably has two or more microphone units. As such, the microphone is suitable, in particular provided and configured, for capturing an ambient sound. Conveniently, an input signal is created by means of the microphone when the ambient sound is captured. The hearing device conveniently has a signal processing unit which is preferably signally connected to the microphone. In particular, during operation, the input signal is fed to the signal processing unit. The hearing device comprises a receiver by means of which an output signal, which conveniently corresponds to the processed audio signal, is emitted, and which is conveniently signally connected to the signal processing unit.

The hearing device is operated according to a method in which the input signal is created based on the ambient sound by means of the microphone. An output signal is provided based on the input signal, and an output sound is emitted based on the output signal by means of the receiver. The non-processed ambient sound present in the area of the receiver is identified, and the ratio between the non-processed ambient sound and the output sound is identified for different frequency bands. The amplitude of the output signal is changed for the frequency band in which the ratio is between an upper limit value and a lower limit value. Conveniently, the signal processing unit is suitable, in particular provided and configured, for at least partially performing one or both methods.

The invention further relates to a hearing device system having two such hearing devices, i.e., a binaural hearing device system. For example, the method is performed separately by each hearing device. However, particularly preferably, a signal exchange occurs therebetween, and if the amplitude is changed for one of the hearing devices, the amplitude is also changed for the same frequency band with the other hearing device, conveniently independent of what the ratio thereof is. Thus, even with a binaural hearing device system, a coordinated behavior is present which does not result in an impaired acoustic impression for the user.

The developments and advantages explained in the context of the method analogously apply to the hearing device/the hearing device system and are transferable among each other, and vice versa.

Other features which are considered as characteristic for the invention are set forth in the appended claims.

Although the invention is illustrated and described herein as embodied in a method of operating a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block diagram of a hearing device;

FIG. 2 is a flow diagram showing a method of operating the hearing device;

FIG. 3 a graph showing a frequency spectrum in which a comb filter artefact is present; and

FIG. 4 is a graph showing a function for changing an amplification factor.

Parts corresponding to one another are provided with the same reference symbols throughout the figures.

### DETAILED DESCRIPTION OF THE INVENTION

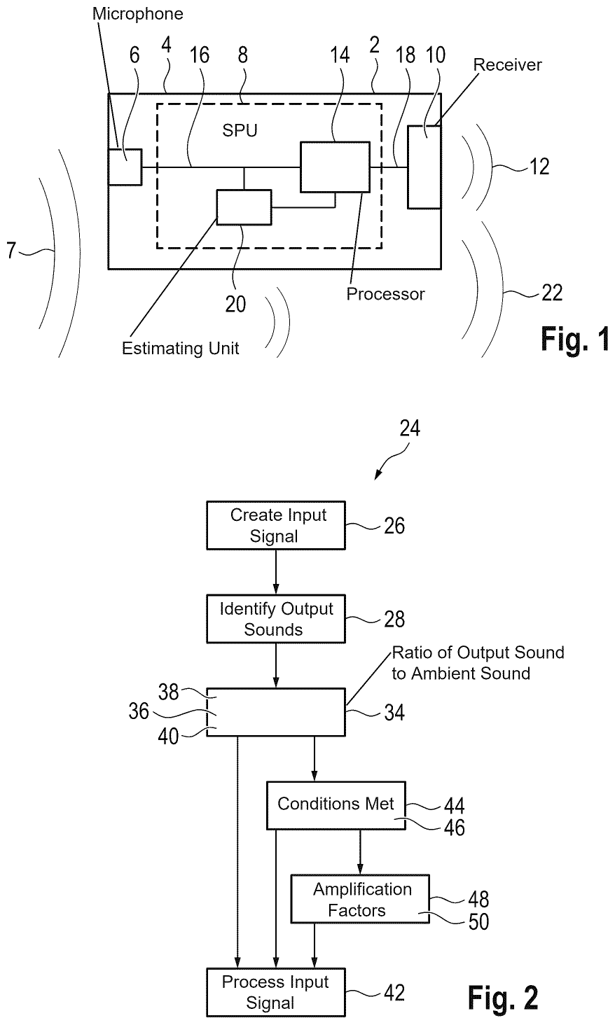

Referring now to the figures of the drawings in detail and first, particularly to FIG. 1 thereof, there is shown a simplified schematic of a hearing device 2. The hearing device 2 has a housing 4 within which a microphone 6 is arranged. As such, an ambient sound 7 may be captured by means of microphone 6. The microphone 6 has multiple microphone units not shown in detail; each being designed as an electromechanical sound transducer or capacitive sound transducer. The microphone 6 is signally connected downstream of a signal processing unit 8. The signal processing unit 8 is signally connected downstream of a receiver 10 by means of which it is possible, when used as intended by a user, to emit output sound 12 into an ear canal of the user not shown in detail.

The signal processing unit 8 has a processing unit 14 by means of which an input signal 16 provided during operation by means of microphone 6 is processed so as to provide an output signal 18. As such, a split is first made over different frequency bands, wherein the individual frequency bands are processed separately. Thus, a frequency-selective amplification and/or attenuation occurs so that, for example, noise or other disturbing sounds are suppressed. For this purpose, the processing unit 14 has a digital sound processor, for example. In addition, compression is performed, for example, so that a frequency spectrum of output signal 18 is reduced compared to input signal 16.

The output signal 18 is passed to receiver 10, so that output sound 12 emitted by receiver 10 corresponds to output signal 18.

The signal processing unit 8 further comprises an estimating unit 20 which is also supplied with input signal 16. The estimating unit 20 comprises two transfer functions. By means of one of them, the resulting output sound 12 is identified based on input signal 16. This is done theoretically, for which processing unit 14 imitates operations to be performed and a frequency response of receiver 10 is taken into account. By means of the other transfer function, the part of ambient sound 7 entering the ear canal past hearing device 2 is estimated, so that the non-processed ambient sound 23 present in the area of receiver is identified. This takes into account the geometric design of the housing 4, such as perforations, and/or the ear canal. This transfer function is created based on a measurement and is adapted to the respective user. If processing unit 14 and/or receiver 10 are not in operation, i.e., if output sound 12 is not created, the user thus solely perceives the non-processed ambient sound 22 which is attenuated compared to ambient sound 7 due to the presence of hearing device 2, for example.

FIG. 2 shows a method 24 of operating the hearing device 2. In a first operation 26, input signal 16 is created based on ambient sound 7 by means of microphone 6. It is passed to signal processing unit 8, i.e., to processing unit 14 and to estimating unit 20.

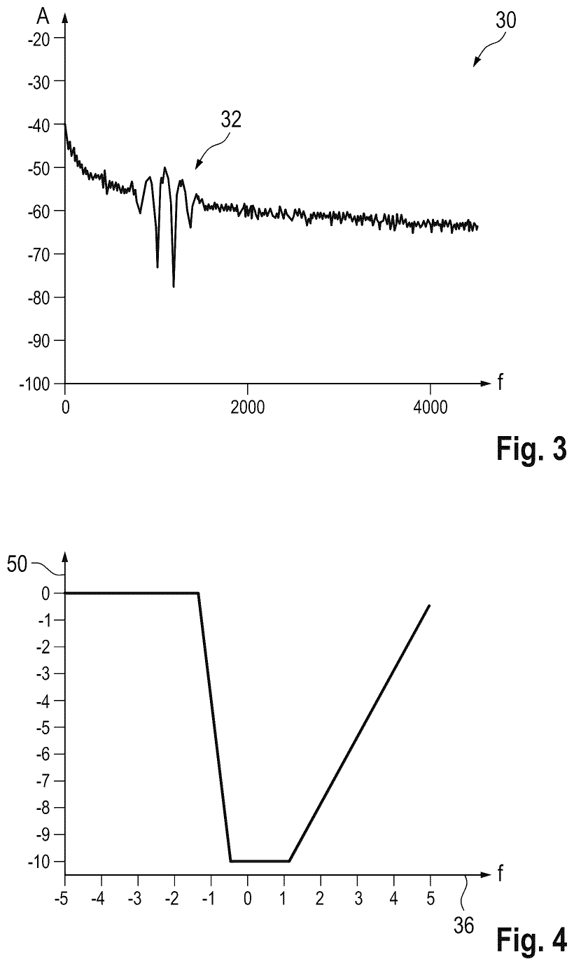

In a subsequent second operation 28, an output sound 12 and a non-processed ambient sound 22 are identified based on the transfer functions by means of estimating unit 20. In this respect, it is possible for a frequency spectrum 30 shown in FIG. 3 to result due to the superimposition of output sound 12 with non-processed ambient sound 22 in the ear canal, in particular in the area of the eardrum. In frequency spectrum 30 shown, a comb filter artifact 32 occurs due to an unfavorable interference between output sound 12 and non-processed ambient sound 22. As such, multiple comparatively sharp minima are present which are at a previous frequency interval relative to one another. They are independent of the frequency-specific amplification and the anatomy of the ear canal and thus differ between different users.

In a subsequent third operation 34, a ratio 36 is identified between non-processed ambient sound 22 and output sound 12 for the different frequency bands into which input signal 16 is split. In this respect, the respective ratio 36 is identified solely for all of the frequency bands with frequencies of between 250 Hz and 2 kHz.

If ratio 36 is greater than an upper limit value 38 or less than a lower limit value 40, a fourth operation 42 is performed. Therein, 6 dB is used as upper limit value 38 and −6 dB is used as lower limit value 40. In the fourth operation 42, processing of input signal 16 is carried out by means of processing unit 14 corresponding to the one adapted to the possible hearing loss of the user, and output signal 18 is created based on input signal 16. Output signal 18 is then passed to receiver 10, so that output sound 12 is emitted by receiver 10 based on output signal 18.

However, if ratio 36 is between upper limit value 38 and lower limit value 40, a fifth operation 44 is performed. Therein, it is checked whether a criterion 46 containing multiple conditions is met. For example, meeting a condition is sufficient for criterion 46 to be met. Alternatively, meeting further conditions is required for criterion 46 to be met.

To check for one of the conditions, output sound 7 is classified. As such, it is checked whether stationary sounds are present which are caused by the speech of many speakers. It is also checked whether the stationary sounds are caused due to engine sounds, i.e., car noise, or the operation of heavy machinery. If this is the case, a condition of criterion 46 is met. Hence, criterion 46 is thus only met if ambient sound 7 is associated with a certain class.

Another such condition is that the amplitude of the respective frequency band is less than a reference amplitude by more than a third limit value or is greater than the same by more than a fourth limit value. The reference amplitude is the average of the amplitudes of the directly adjacent frequency bands of output sound 12. The third limit value is also equal to 10 dB, just like the fourth limit value. If this is the case, a condition of criterion 46 is also met.

As a further condition, it is checked for whether multiple of the frequency bands, i.e., for a first number which is 2, the respective amplitude is less than the respective reference amplitude by more than the third limit value. It is also checked whether for multiple of the frequency bands, i.e., for a second number which is 3, the respective amplitude is greater than the respective reference amplitude by more than the fourth limit value. If this condition is met, comb filter artifact 32 is present.

However, independently of whether one of the other conditions is met, criterion 46 is always not met if the frequency band solely corresponds to speech or tonal music. That is, if solely speech or tonal music contribute to the respective amplitude in the respective frequency band. As such, the speech may be caused by a single other speaker or the user of hearing device 2 themselves.

If criterion 46 is not met, for example because none, not all or at least not a predetermined number of conditions are met, or if the frequency band solely corresponds to speech or tonal music, fourth operation 42 is also performed. Otherwise, a sixth operation 58 is performed. Therein, an amplification factor 50 associated with the frequency band is changed, namely reduced. This is performed for all of the frequency bands for which ratio 36 is between both limit values 38, 40 and for which criterion 46 is met. The changed amplification factors 50 are then fed to processing unit 14.

Subsequently, the fourth operation 42 is performed again. However, in this respect, amplification factors 50 changed in sixth operation 48 are and used for the respective frequency bands. For the remaining frequency bands, the amplification factors defined based on the hearing less are adopted.

Due to changed amplification factors 50, the amplitude of output signal 18 is changed. As a consequence, the actually resulting ratio of the frequency bands between non-processed ambient sound 22 and output sound 12 is either above upper limit value 38 or below lower limit value 40, so that the formation of comb filter artifacts 32 is avoided. As ratio 36 is solely created for frequency bands of between 250 Hz and 200 kHz, solely the amplitude for the frequency bands with frequencies of between 250 Hz and 2 kHz is changed. Moreover, changing the amplitude of the frequency bands solely occurs if criterion 46 is met.

The changes in amplification factor 50 in sixth operation 48 occur as a function of ratio 36. FIG. 4 plots a corresponding function of the changes in amplification factor 50 versus ratio 36, wherein dB ld is used as an exemplary unit on the axes. At a ratio of between −0.5 dB ld (log dualis; log2) and 1 dB ld, 10 dB ld is subtracted from the amplification factor for the change, i.e., 60 dB. From a ratio 36 of 1 dB ld to 6 dB ld, linearly less is subtracted. Thus, at a ratio of 3 dB ld, 5 dB ld are subtracted from amplification factor 50, for example. Consequently, the function is designed to be substantially notch-like.

By means of the function, the target value for the change of amplification factor 50 is indicated. The change itself is gradual, i.e., over a certain time window to the target value specified by means of the function. Thus, a hard transition is avoided which is otherwise perceived as unpleasant by the user.

The invention is not limited to the exemplary embodiment described above. Rather, other variations of the invention may also be derived therefrom by a person skilled in the art, without departing from the subject matter of the invention. In particular, all of the individual features described in the context of the exemplary embodiment may also be combined in other ways, without departing from the subject matter of the invention.

The following is a summary list of reference numerals and the corresponding structure used in the above description of the invention:
2 Hearing device
4 Housing
6 Microphone
7 Ambient sound
8 Signal processing unit
10 Receiver
12 Output sound
14 Processing unit
16 Input signal
18 Output signal
20 Estimating unit
22 Non-processed ambient sound
24 Method
26 First operation
28 Second operation
30 Frequency spectrum
32 Comb filter artifact
34 Third operation
36 Ratio
38 Upper limit value
40 Lower limit value
42 Fourth operation
44 Fifth operation
46 Criterion
48 Sixth operation
50 Amplification factor

1. A method for operating a hearing device, which comprises the steps of:
generating an input signal based on an ambient sound by means of a microphone;
providing an output signal based on the input signal;
emitting an output sound based on the output signal by means of a receiver;
identifying non-processed ambient sound present in an area of the receiver;
determining a ratio between the non-processed ambient sound and the output sound identified for different frequency bands; and
changing an amplitude of the output signal for a frequency band in which the ratio is between an upper limit value and a lower limit value.

2. The method according to claim 1, which further comprises using 6 dB as the upper limit value and/or −6 dB as the lower limit value.

3. The method according to claim 1, which further comprises changing the amplitude for the frequency bands with frequencies of between 250 Hz and 2 kHz.

4. The method according to claim 1, which further comprises changing an amplification factor associated with the frequency band by means of which the output signal is created.

5. The method according to claim 4, which further comprises gradually adapting the amplification factor to a target value.

6. The method according to claim 1, which further comprises changing the amplitude only if a criterion is met.

7. The method according to claim 6, wherein the criterion is only met if the amplitude is less than a reference amplitude by more than a third limit value or is greater than the reference amplitude by more than a fourth limit value.

8. The method according to claim 7, wherein the criterion is only met if, for a first number of the frequency bands, the amplitude is less than the reference amplitude by more than the third limit value, and/or if, for a second number of frequency bands, the amplitude is greater than the reference amplitude by more than the fourth limit value.

9. The method according to claim 6, wherein the criterion is only met if the ambient sound is associated with a certain class.

10. The method according to claim 6, wherein the criterion is not met if the frequency band solely corresponds to speech or tonal music.

11. A hearing device, comprising:
a microphone;
a receiver; and
a signal processing unit for executing the method according to claim 1.
